(19) United States
(12) Patent Application Publication
(10) Pub. No.: US 2023/0276133 A1
(43) Pub. Date: Aug. 31, 2023

(54) EXPOSURE TIME CONTROL USING MAP DATA

(71) Applicant: TuSimple, Inc., San Diego, CA (US)

(72) Inventors: Niranjan Shenoy BELLARE, Canton, MI (US); Xiaoling HAN, San Diego, CA (US)

(21) Appl. No.: 18/172,576

(22) Filed: Feb. 22, 2023

Related U.S. Application Data
(60) Provisional application No. 63/268,594, filed on Feb. 25, 2022.

(51) Int. Cl. H04N 23/73; H04N 23/71; B60R 11/04

(52) U.S. Cl. CPC H04N 23/73; H04N 23/71; B60R 11/04

(57) ABSTRACT

Disclosed are devices, systems and methods for controlling exposure time of an image sensor mounted on a vehicle. One exemplary method includes configuring map data to include location information associated with exposure time information for the image sensor; obtaining an initial exposure time for the image sensor based on the map data; and adjusting the initial exposure time to obtain a target exposure time for the image sensor based on real time parameters.

### CROSS-REFERENCE TO RELATED APPLICATIONS

This application claims priority to and the benefit of U.S. Provisional Application No. 63/268,594, filed on Feb. 25, 2022. The aforementioned of which is incorporated by reference in its entirety.

### TECHNICAL FIELD

This document relates to tools (systems, apparatuses, methodologies, computer program products, etc.) for semi-autonomous and autonomous control of vehicles, and more particularly, exposure time control for image sensors mounted on vehicles.

### BACKGROUND

Autonomous vehicle navigation is a technology for sensing the position and movement of a vehicle and, based on the sensing, autonomously controlling the vehicle to navigate towards a destination. Autonomous vehicle navigation can have important applications in transportation of people, goods and services. In order to ensure the safety of the vehicle, as well as people and property in the vicinity of the vehicle, autonomous algorithms implemented by these applications, various measurement data is obtained.

### SUMMARY

Disclosed are devices, systems and methods for controlling exposure time of image sensors mounted on vehicles. The disclosed technology can be applied to improve the precision of exposure time of image sensors, which can provide images with better qualities and allow to more accurately detect and evaluate of environments of the vehicles.

In one aspect, a method of controlling exposure time of an image sensor mounted on a vehicle is provided. The method comprises: configuring map data to include location information associated with exposure time information for the image sensor, obtaining an initial exposure time for the image sensor based on the map data, and adjusting the initial exposure time to obtain a target exposure time for the image sensor based on real time parameters.

In another aspect, a vehicle is provided to comprise: image sensors having respective identifications (IDs) and disposed at different locations of the vehicle to capture images regarding an environment external of the vehicle, a control unit communicatively coupled to the image sensors and configured to control exposure time of the image sensors based on map data and real-time parameters such that the exposure time of the image sensors disposed at the different locations of the vehicle is controlled to be different from one another, and one or more sensors communicatively coupled with the control unit and provide the real-time parameters to the control unit.

In another exemplary aspect, the above-described method is embodied in a non-transitory computer readable storage medium. The non-transitory computer readable storage medium includes code that when executed by a processor, causes the processor to perform the methods described in this patent document.

In yet another exemplary embodiment, a device that is configured or operable to perform the above-described methods is disclosed.

The above and other aspects and features of the disclosed technology are described in greater detail in the drawings, the description and the claims.

### BRIEF DESCRIPTION OF THE DRAWINGS

FIG. 1 shows an example of a schematic diagram that illustrates a truck based on some implementations of the disclosed technology.

FIG. 2 shows an example of an exposure setting scheme of obtaining target exposure time for a corresponding image sensor based on some implementations of the disclosed technology.

FIG. 3 shows an example diagram that illustrates how the target exposure time is determined based on some implementations of the disclosed technology.

FIG. 4 shows a schematic diagram for updating map data including exposure time information based on some implementations of the disclosed technology.

FIG. 5 shows an example of a hardware platform that can implement some techniques described in the present document.

### DETAILED DESCRIPTION

The transportation industry has been undergoing considerable changes in the way technology is used to control the operation of the vehicles. A semi-autonomous and autonomous vehicle is provided with a sensor system including various types of sensors to enable a vehicle to operate in a partially or fully autonomous mode. Examples of the sensors included in the sensor system may include one or more of image sensors, a Radio Detection And Ranging (RADAR) sensor, a Light Detection And Ranging (LIDAR) sensor, a Light Amplification by Stimulated Emission of Radiation (LASER) sensor, an ultrasound sensor, an infrared sensor, or any combination thereof. The image sensors mounted on the vehicle operate to capture images regarding an environment external of the vehicle and the captured images are used to detect and evaluate the environment. Since many operation decisions of the vehicle in the partially or fully autonomous mode are made based on the detecting and the evaluating of the environment, there has been a need to obtain more reliable images from the image sensors in the vehicles. An autonomous vehicle (ego) may use the captured images to perform certain calculations and determine a navigation strategy for the ego. Therefore, underexposed or overexposed images may cause certain errors in the ego navigation. Such errors may include missing detection of certain surrounding signs and objects or miscalculating distances to the objects. In a typical autonomous driving scenario, the feedback loop through the image calculation and navigation that may provide an indication about whether captured images had quality issues may prove to be too slow for high-speed driving conditions.

Various implementations of the disclosed technology are disclosed to provide techniques to make improvements in obtaining more reliable images with higher qualities from image sensors. The image sensors may record still images, video, and/or combinations thereof. Image sensors may be used alone or in combination with other sensors to identify objects, users, and/or other features. Two or more image sensors may be used in combination to form, among other things, stereo and/or three-dimensional (3D) images. The stereo images can be recorded and/or used to determine depth associated with objects and/or users in a vehicle. Further, the image sensors used in combination may determine the complex geometry associated with identifying characteristics of objects, a user, or others. For example, the image sensors may be used to determine dimensions between various features of an object (e.g., the depth/distance from a certain location of a vehicle to the object, a linear distance between edges of the object, etc.). These dimensions may be used to verify, record, and even modify characteristics that serve to identify an object. The image sensors may also be used to determine movement associated with objects and/or users within the vehicle. The number of image sensors used in a vehicle may be increased to provide greater dimensional accuracy and/or views of a detected image in the vehicle.

In the implementations of the disclosed technology, an image sensor is configured to capture images according to an exposure setting that sets exposure time which is time span for which a subject to be captured by the image sensor is exposed to the light. The amount of light received by the image sensor is based on the exposure information setting, e.g., exposure time, and the image captured by the image sensor has a quality based on the exposure information setting. To guarantee a certain level of the accuracy and properly generate an image of the environment external to the vehicle, under certain scenarios, the exposure time of an image sensor needs to be adjusted. For example, while a vehicle drives through a tunnel or under a bridge where the amount of light incident on the image sensor is relatively small due to the tunnel and the bridge, the exposure time for the image sensor needs to be adjusted to obtain reliable images from the image sensor. In some examples, adverse weather conditions (e.g., rain, snow, fog, unfavorable lighting conditions, etc.) can cause the amount of light incident on the image sensor to reduce as compared to normal weather conditions and thus the weather condition can be a factor to adjust the exposure time for its image sensor. There are more scenarios that require the adjustment of the exposure time of the image sensor to provide accurate image information regarding an environment external of the vehicle. In addition, the image information obtained by the image sensor can be utilized for various evaluations/analysis for operations of the vehicle. Thus, providing the accurate image information can allow to improve the accuracy in various operations/controls of the vehicle.

The implementations of the disclosed technology may control exposure time of the image sensors to obtain more reliable images from the image sensors based on map data that includes exposure time information. By using the map data, the implementations of the disclosed technology enable to control the exposure time to improve the precision of exposure time and save computing resources. The disclosed techniques can be applied to the image sensors provided at various positions of the vehicle, for example, a front, a rear, and/or a side of the vehicle.

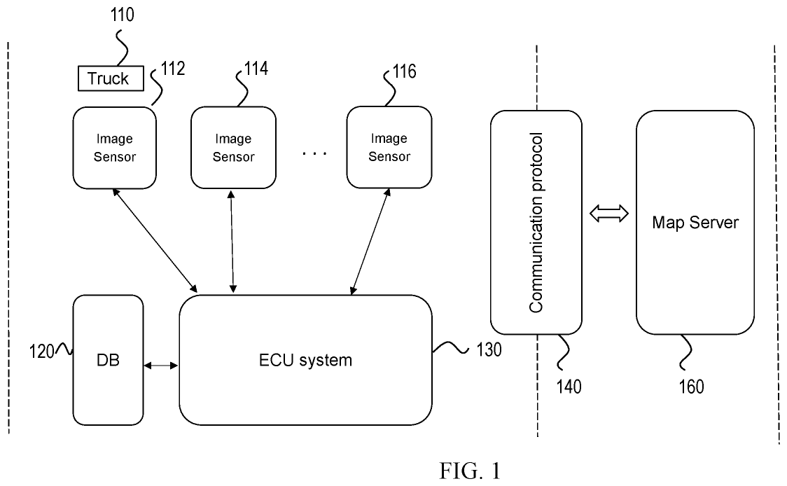

FIG. 1 shows an example of a schematic diagram that illustrates a truck based on some implementations of the disclosed technology. The truck 110 is shown as the example only but the disclosed technology is not limited thereto. For example, the implementations of the disclosed technology may be implemented in other vehicles, such as cars, motorcycles, buses, boats, airplanes, or robot devices. The truck may operate autonomously or semi-autonomously.

Various types of sensors are mounted on the truck 110, which include the multiple image sensors 112, 114 and 116, a light sensor (not shown), a temperature sensor (not shown), a pressure sensor (not shown), etc. In some implementations, the image sensors 112, 114, and/or 116 include a pixel array having multiple pixels for converting an optical signal into an electrical signal and circuitries for operating the multiple pixels and outputting the generated signals from the multiple pixels as the digital signals. Each of the image sensors 112, 114 and 116 includes any circuitry that converts an optical image into an electronic signal. In the implementations, the image sensors 112, 114, and 116 receive incident light according to the exposure time information and generates the optical image corresponding to the incident light received according to the exposure time information. The exposure time information may control the amount of light received by the image sensors 112, 114, and 116 such that the greater amounts of photocharges can be collected under the same light. In some cases, the controlling of the exposure time can help to reduce or avoid undesired lighting issues such as glair issues and shadow issues. In some implementations, the image sensors 112, 114 and 116 may correspond to cameras that are configured to capture images exterior of the truck 110 and disposed at various locations of the truck 110. For example, the image sensor 112 may be disposed at a front portion of the truck 110 and having a forward view, the image sensor 114 may be disposed at a side portion of the truck 110 and having a side view, and the image sensor 116 may be disposed at a rear portion of the truck 110 and having a rearward view.

The image sensors 112, 114, and 116 are communicatively coupled to the Electronic Control Unit (ECU) system 130. The image sensors 112, 114 and 116 and the ECU system 130 engage in two-way communication, which enables the ECU system 130 to receive data from the image sensors 112, 114 and 116 and transmit commands/information to the image sensors 112, 114 and 116. The ECU system 130 may include various processing units to control and support the operations of the truck 110. For example, the ECU system 130 may include an image processing unit operable to process the electrical signals from the image sensors 112, 114 and 116 and provide image data. In the implementations of the disclosed technology, the ECU system 130 may include an exposure control unit operable to control exposure time of the image sensors installed on the truck 110.

In some implementations, the ECU system 130 may be communicatively coupled with the database (DB) 120 that stores various algorithms and data that are used to support the control of the sensors. In some implementations, the DB 120 includes map data that is configured according to some implementations of the disclosed technology. In the example, the map data includes geo-information such as topographic and general reference map information related to the shape and geolocation of ground landmarks such as hills, mountains, shorelines, or others, and may further provide data, e.g., geolocation of roadways, railways, airports, seaports, levies, retaining walls, dams, and any other manmade structures. In the example, the map data as stored in the DB 120 can further include exposure time information for corresponding locations included in a map. For example, for a tunnel, the DB 120 stores the map data that includes both of location information of the tunnel and the exposure time information corresponding to the tunnel. The exposure time information will be used to control exposure time of an image sensor of the vehicle such that the vehicle can get an image with better qualities and quickly evaluate environments of the vehicle. Configuring of the map data will be further discussed later in this patent document.

Although FIG. 1 shows that the DB 120 is disposed outside of the ECU system 130, the DB 120 may be located in the ECU system 130. In some implementations, multiple ECU systems can be disposed on the truck 110 such that each of the multiple ECU systems controls one or more sensors. In some implementation, each ECU system is configured to control its corresponding sensor. In some other implementations, some redundancy may be intended such that at least two ECU systems are configured to control a single sensor in case of an occurrence of an error in any one of the ECU systems. In some implementations, the ECU system 130 may be communicatively coupled with the map server 160 that is disposed remotely outside the truck 110. The ECU system 130 and the map server 160 may communicate with each other through a communication protocol 140. Examples of the communication protocol 140 may include LTE, Wi-Fi, vehicle-to-vehicle communications, etc. In some implementations, a communication interface may be implemented according to the communication protocol 140 between the map server 160 and the ECU system 130 such that the map server 160 provides map data to the ECU system 130 such that the ECU system 130 controls the image sensors 112, 114, and 116 based on the map data.

In some implementations, the ECU system 130 may be provided to configure the map data. Algorithms to configure the map data are predetermined and stored in the ECU system 130. The algorithms for configuring the map data, which is applied to the ECU system 130, can be updated after the algorithms were applied to the ECU system 130 for the first time. The update of the algorithms can occur at a regular basis or whenever the update is available. The map server 160 can communicate with the ECU system 130 through the communication protocol 140 to assist the configuring of the map data. In some implementations, the map server 160 may include map data that is configured based on the implementations of the disclosed technology as further discussed later in this patent document. In some implementations, the ECU system 130 can provide information stored in the DB 120 to the map server 160 through the communication protocol 140 and/or provide information stored in the map server 170 to the DB 120 through the communication protocol 140.

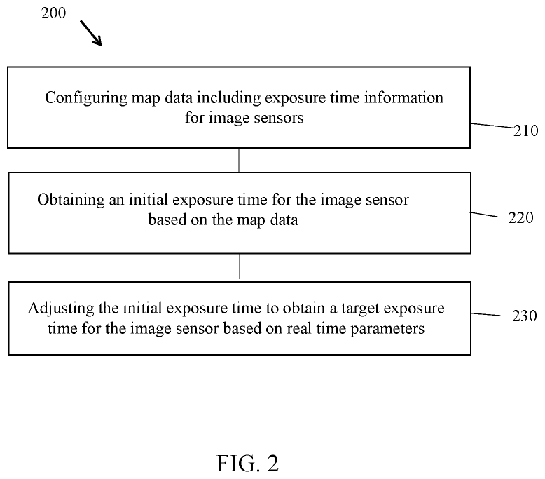

FIG. 2 shows an example scheme of controlling exposure time of an image sensor based on some implementations of the disclosed technology. The exposure control scheme as illustrated in FIG. 2 can be employed by, for example, the exposure control unit of the ECU system 130 to control the exposure time of the image sensors 112, 114 and 116, which are shown in FIG. 1.

In the implementations of the disclosed technology, the exposure time of the image sensors is controlled based on map data to adjust the exposure time in short time and improve the perception of the images from the image sensors. In the implementations of the disclosed technology, the map data can provide both location related information and exposure time information for controlling exposure time of image sensors of the vehicle. The exposure time information can be predetermined for various locations on a map. For example, various algorithms and softwares can be utilized such that the exposure time information can be predetermined based on landform measurement, topographic data, and any other information of the locations on the map. For example, for a location A on a map, the corresponding exposure time information for controlling image sensor is stored on the map together with the location information. Various available algorithms/softwares can be applied to collect the landform measurements and topographic data of a certain coordinate.

Referring to FIG. 2, at operation 210, the map data is configured to include exposure time information for image sensors. Configuring the map data to include exposure time information includes storing exposure time information on a map. For various locations on the map, corresponding exposure time is stored such that locations on the map are associated with corresponding exposure time information. For example, the map data includes exposure time information associated with a location A where is located at an entry of a tunnel and exposure time information associated with a location B where is located at an exit of a tunnel. The exposure time information stored on the map for the locations A and B would be different from each other such that the image sensors of the truck can adjust the luminance changes accordingly. The exposure time information included in the map data may be predetermined under the assumption that the weather is normal (for example, average temperature for the location) and prestored on the map.

In some implementations, when the map data is configured to include both the geolocation information and exposure time information, whether/how to display the geolocation information and/or the exposure time information on the display can be determined in various manners. In the implementations, as a part of the user interface used to implement the vehicle entertainment and driving supports, a display is provided within a vehicle. Various applications can be executed upon a selection of a driver on the display, which include a map application configured to display a map. In the example, upon the selection of the driver of the map application on the display, the map is displayed on the display to provide geolocation information of a certain area including a location where the vehicle is currently traveling.

In some implementations, the vehicle has a default setting which determines whether/how to display the geolocation information and/or the exposure time information on the display. In some implementations, the vehicle allows a user (e.g., a driver) to change the default setting and make changes to a setting to display whether/how to display the geolocation information and/or the exposure time information. The user can change the display setting during the trip or before/after the trip by, e.g., touching a menu option in the display of the vehicle and enter his or her preferred option. In some implementations, geolocation information only can be displayed on the display while the exposure time information is used to control the exposure time of the image sensors without being displayed on the display. In some implementations, both of the geolocation information and the exposure time information can be displayed on the display. Displaying the geolocation information and/or the exposure time information can include not only displaying such information with actual values of location data and/or exposure time data and but also displaying such information utilizing symbols, graphics, icons, etc. For example, displaying the exposure time information can be implemented using symbols instead of the actual values of exposure time information. For example, when the display shows the map including “tunnel,” the geolocation information of the “tunnel” can be shown with a symbol indicating longer exposure time instead of actual values of exposure time information. Various modifications can be suggested to display the map data on the display.

In some implementations, the map data including exposure time information is stored in the DB 120. In some implementations, the map data including exposure time information is stored in a separate unit, for example, map module, which is provided in the vehicle. In some other implementations, the map data including exposure time information is obtained online through communication links from an external map server.

In some implementations, the map data is configured in the form of a look-up table having a location on a map and an image sensor identification (ID) as inputs. In this case, the look-up table includes exposure time information that is associated with both the location information on a map and the image sensor IDs. The image sensors on the vehicle has a unique ID and the ID information for image sensors can be pre-stored. Since the image sensors mounted at various locations of the vehicle have the respective image sensor IDs, the image sensor IDs can provide in-vehicle location information that represents where the image sensors are located inside the vehicle. By configuring the map data to include exposure time information associated with both the location information and the image sensor IDs, it is possible to allow the image sensors associated with same location information on the map to have different exposure time. Associating the image sensor ID with corresponding exposure time information for a particular location on a map can help the image sensors to operate with more precise exposure time information based on the locations of the image sensors within the truck.

In the implementations of the disclosed technology, the image sensors can be provided with different exposure time information for a same location on a map. For example, when the map displayed in the display shows the tunnel, the ECU system provides different exposure time information to the image sensors such that the image sensors can operate with different exposure time information when entering the tunnel. Given that some of the image sensors are disposed at the front of the truck and facing to the front, some of the image sensors are disposed at the side of the truck and facing to the side, and some of the image sensors are disposed at the rear of the truck and facing to the rear, even when the image sensors are associated with the same location information on the map, the desired exposure time for the image sensors may be different from one another. For example, in the case of the truck going out of the tunnel, the image sensor at the front of the truck needs less exposure time as compared to that at the rear of the truck. For example, in the case of the truck going into the tunnel, the image sensor at the front of the truck needs more exposure time as compared to that at the rear of the truck. Thus, for the image sensors associated with the same location information on the map, the exposure time information for the image sensors can be configured differently based on the image sensor IDs by considering the in-vehicle locations of the image sensors on the vehicle.

At operation 220, the initial exposure time is obtained for a particular image sensor based on the map data that has been configured at the operation 210. In some implementations, the initial exposure time for the particular image sensor is determined based on the values included in the map data. For example, for the particular image sensor of the truck, the location of the truck can be figured out using the global positioning system (GPS) system of the vehicle or others. When the location of the truck is identified, corresponding exposure time information to the location of the vehicle is obtained as the initial exposure time for the particular image sensor. In some implementations, the initial exposure time is obtained based on the map data that is associated with the location of the truck and the image sensor ID of the particular image sensor. When the map data is configured in the form of the look-up table with the location on the map and the image sensor ID, the initial exposure time for the particular image sensor can be obtained by obtaining the location of the truck and reading the look-up table using the image sensor ID associated with the particular image sensor.

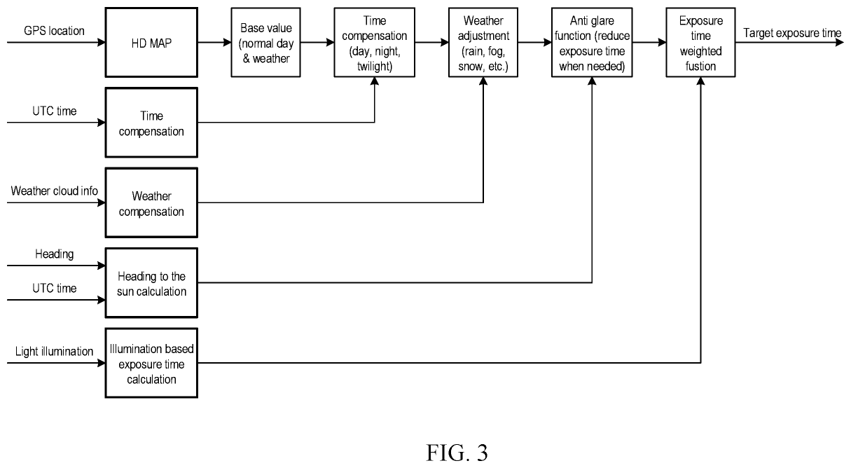

At operation 230, the initial exposure time is adjusted to obtain a target exposure time for the particular image sensor based on real time parameters. The operation 230 adds an additional aspect to allow the image sensors in the truck to provide images with better qualities and more accurately detect and evaluate of environment of the truck by adjusting the initial exposure time based on real time parameters. FIG. 3 shows an example diagram that illustrates examples of the real time parameters used to obtain the target exposure time based on some implementations of the disclosed technology. Various real time parameters are shown as examples, which include time information, weather information, heading information, and light illumination information. Those real time parameters may be received in real time through communication protocols and stored in the vehicle. For example, the exposure time control unit of the ECU system is in communication with one or more units that are configured to provide real-time parameter information and operates to adjust the initial exposure time based on the real-time parameter for each image sensor that is located at a corresponding location of the vehicle. The base value of the exposure time, which is obtained from the map, corresponds to the initial exposure time obtained at the operation 220.

The adjusting of the initial exposure time can be performed differently based on conditions that the initial exposure time is obtained. For example, the adjusting of the initial exposure time can be done differently in the case that the initial exposure time was obtained on the assumption of the afternoon time from the case that the initial exposure time was obtained on the assumption of the evening time. As mentioned above, in one example, the initial exposure time included in the map data is predetermined under the assumption that the weather is normal and such assumption is also applied to the example scenarios for adjusting the initial exposure time as discussed below.

The below provides examples of the real-time parameters that can be considered to adjust the initial exposure time to obtain the target exposure time. In some implementations, all of the real-time parameters provided below can be considered to adjust the initial exposure time. In some implementations, only some of the real time parameters provided below can be considered to adjust the initial exposure time. The number of real-time parameters and which real-time parameter is to be considered to adjust the initial exposure time can be determined based on various factors including the location of the truck, amount of calculation needed to make the adjustment, etc.
1) Time information: Time information includes local time and/or date, for example, whether it is day, night, twilight, or others. The amounts of light incident on the image sensors of the truck can change depending on times of the day. For example, if the truck operates in the evening when it is dark, the time information allows to add certain exposure time to the initial exposure time such that the added exposure time can compensate the reduced amount of the light incident on the image sensors in the evening as compared to the amount of light incident on the image sensors in the afternoon (when it is not dark). In this case, as the example, it has been assumed that the initial exposure time information is determined based on the assumption that it is not dark.
2) Weather information: The weather information includes whether it is cloud, rainy, sunny, foggy, snowing, or others, and allows to add or reduce certain exposure time to or from the initial exposure time. For example, if the weather information indicates that it is rainy, the exposure time control unit operates to add a certain exposure time to the initial exposure time such that the added exposure time can compensate the reduced amount of light incident on the image sensors in the rainy day as compared to the amount of light incident on the image sensors in the non-rainy day. In this case, as the example, it has been assumed that the initial exposure time information is determined based on the assumption that it is not dark.
3) Heading information: The heading information includes information whether the particular image sensor is in a direction heading to the sun or away from the sun and allows to add or reduce certain exposure time to or from the initial exposure time. For example, if the particular image sensor is heading to the sun, the exposure time control unit operates to reduce a certain exposure time from the initial exposure time when the initial exposure time is obtained under the assumption that the sun is not heading to the sun. In the example, if the particular image sensor is heading away from the sun, the exposure time control unit operates to add a certain exposure time to the initial exposure time when the initial exposure time is obtained under the assumption that the sun is not heading away from the sun. The heading information may be related to the anti-glare function of the vehicle.
4) Light illumination information: The light illumination information may be obtained from one or more light sensors (not shown) mounted on the truck and can be used to adjust the initial exposure time. The light sensors may include any circuitry that can detect the ambient light, or illuminance, around the truck. Thus, some implementations of the disclosed technology provide controlling exposure time for the image sensors based on map data combined with light illumination information from light sensors. For example, in the case of the tunnel, controlling exposure time only based on the light illumination information from the light sensors is not desirable since it is hard for the light sensors to respond in less than a few milliseconds.

In some implementations, the real-time parameters as shown in FIG. 3 can be considered to obtain the target exposure time according to the following algorithms. In some implementations, the following algorithms can be applied to the ECU system of the truck. In the example, the algorithms include the feedforward calculation to obtain the feedforward exposure time value and the feedback calculation to obtain the feedback exposure time value. The final exposure time value corresponding to the target exposure time can be determined based on the feedforward exposure time value and the feedback exposure time value.

First, the feedforward calculation is performed as follows:
1) The pre-stored exposure time is obtained as the initial exposure time based on the map data and the current GPS location. According to the implementations of the disclosed technology, the map data is configured to include, for a particular location, location information and the initial exposure time information. Thus, when the location information of the truck is identified (e.g., by obtaining the GPS location of the truck), the corresponding initial exposure time can be obtained from the map data. The corresponding initial exposure time obtained from the map data can be used in the feedforward calculation.

Some of the real-time parameters as discussed above will be used in the feedforward calculation, while the remaining of the real-time parameters will be used in the feedback calculation. In the example, the time information, the weather information, and the heading information are used in the feedforward calculation, while the light illumination information is used in the feedback calculation. The feedforward calculation can continue as follows to adjust the initial exposure time based on the time information, weather information, and the heading information.
2) The time information such as time and date can be used to adjust the initial exposure time. For example, during the evening, a certain exposure time is added to the initial exposure time such that a corresponding image sensor is exposed to light for a longer exposure time even in the evening.
3) The weather information is used to make further adjustments. For example, a few milliseconds can be added if it is rainy such that a corresponding image sensor is exposed to light for a longer exposure time even when it is rainy.
4) The heading information is used to make further adjustments. For example, when the image sensor is heading to the sun, the initial exposure time is reduced to avoid the glare issue.

The exposure time value obtained after the feedforward calculation may be referred to as the feedforward exposure time value.

The feedback calculation is performed as follows:
1) The light illumination information is used to make further adjustment. For example, to avoid shadow issues, the exposure time for the certain image sensors need to be further adjusted. The exposure time value obtained after the feedback calculation may be referred to as the feedback exposure time value.

The final calculation is performed as follows:
1) By default, the final exposure time value is obtained using the following equation:

Final exposure time value={0.5*feedforward exposure time value+0.5*feedback exposure time value}

In the equation above, the equal weight value of 0.5 is given to the feedforward exposure time value and the feedback exposure time value. The weight value of 0.5 is the example only and other values can be used.
2) The more the variance (0˜+/100%), the less weight of the feedback is given. Thus, the final exposure time value is obtained using the following equation:

Final exposure time value=|variance|*feedforward exposure time value+(1|variance|)*feedback exposure time value
3) In certain area, the specific equation is used. For example, for the area such as right in the entrance of a tunnel, since the light sensor has some delay to response, the final value is obtained using the following equation:

Final exposure time value=0.9*feedforward exposure time value+0.1*feedback exposure time value.

In the equation above for obtaining the final exposure time values, the weight values are examples only.

Some implementations of the disclosed technology can adjust exposure time of the image sensors fast enough according to environmental conditions outside the vehicle. In addition, using the map data including pre-stored exposure time information for image sensors, it is possible to save computing resources in determining exposure time. The disclosed exposure time control can also ensure image data from the image sensors to have a reliable quality regardless of the variations of the peripheral conditions such as brightness and directions of the sun.

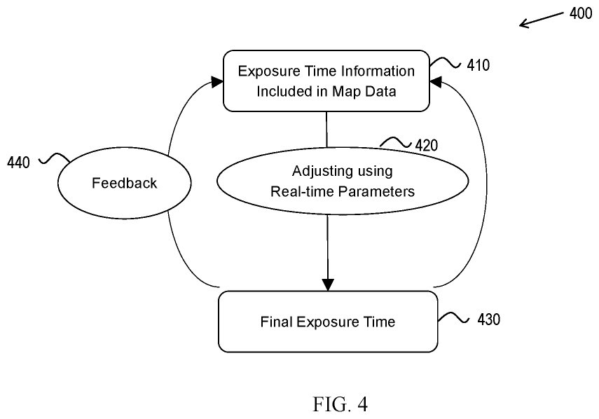

FIG. 4 shows a schematic diagram for updating map data including exposure time information based on some implementations of the disclosed technology. Referring to FIG. 4, at the operation 410, the map data is configured to include exposure time information. At operation 420, the exposure time information is obtained from the map data based on a location of a particular image sensor. At operation 430, the final exposure time is determined. At operation 440, the final exposure time determined for the particular image sensor is feedback to the map data module/server such that the exposure time information included in the map data for the corresponding location is updated.

In some implementations, the map data can be updated using machine learning/artificial intelligence (AI) applications that perform various types of data analysis to automate analytical model building. For example, the machine learning/AI applications employ algorithms to evaluate the final exposure time determined for the image sensors and suggest recommendations to update exposure time information stored on the map. For example, the machine learning/AI applications employ algorithms to refine the final exposure time that is determined for the image sensors disposed at various locations. By applying the machine learning/AI applications to the exposure time control disclosed in this patent document, it is possible to continue improving the algorithms for the exposure time control technique to improve the perceptions of the images from the image sensors.

In some implementations, the updating of the map data may be performed by a fleet of vehicles. A vehicle may report its exposure timing and location to a central server that is remotely disposed. The vehicles in the fleet may communicate with the central server according to proper communication protocols. Upon receiving reports from the vehicles, the server may update map data and push out the updated map data to all vehicles in the fleet. In some implementations, the updating of the map data may be performed at predetermined intervals by the vehicle itself or the central server. In some implementations, the map data including exposure time information is prestored in a vehicle. In some implementations, a new map data with exposure time may be uploaded to a vehicle prior to commencing its travel.

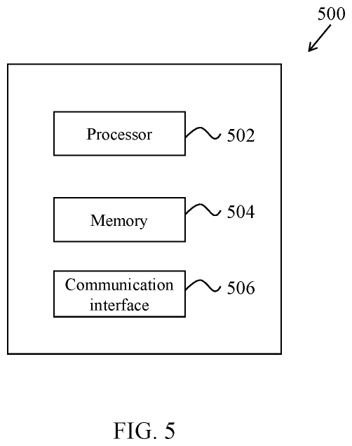

FIG. 5 shows an example of a hardware platform 500 that can be used to implement some of the techniques described in the present document. For example, the hardware platform 500 may implement the method, for example, as shown in FIG. 5 or may implement the various modules described herein. The hardware platform 500 may include a processor 502 that can execute code to implement a method. The hardware platform 500 may include a memory 504 that may be used to store processor-executable code and/or store data. The hardware platform 500 may further include a communication interface 506. For example, the communication interface 506 may implement automotive ethernet and/or controller area network (CANbus).

Embodiments of the disclosed technology include a method of controlling exposure time of an image sensor mounted on a vehicle. The method comprises: configuring map data to include location information associated with exposure time information for the image sensor; obtaining an initial exposure time for the image sensor based on the map data; and adjusting the initial exposure time to obtain a target exposure time for the image sensor based on real time parameters.

Embodiments of the disclosed technology include a vehicle comprising image sensors having respective identifications (IDs) and disposed at different locations of the vehicle to capture images regarding an environment external of the vehicle; a control unit communicatively coupled to the image sensors and configured to control exposure time of the image sensors based on map data and real-time parameters such that the exposure time of the image sensors disposed at the different locations of the vehicle is controlled to be different from one another; and one or more sensors communicatively coupled with the control unit and provide the real-time parameters to the control unit.

In some implementations, the real-time parameters include weather information, time information, information as to whether the vehicle is heading to a sun, light illumination information. In some implementations, the one or more sensors include a light sensor configured to detect light illumination information around the vehicle. In some implementations, the image sensors include a first image sensor disposed at a front portion of the vehicle and a second image sensor disposed at a rear portion of the vehicle, and wherein the exposure time of the first image sensor is controlled to have a value less than that of the second image sensor. In some implementations, the image sensors include a first image sensor disposed at a front portion of the vehicle and a second image sensor disposed at a rear portion of the vehicle, and wherein the exposure time of the first image sensor is controlled to have a value greater than that of the second image sensor.

Embodiments of the disclosed technology include a non-transitory computer-readable program storage medium having instructions stored thereon, the instructions, when executed by a processor, causing the processor to: obtain an initial exposure time for the image sensor based on map data, wherein the map data is configured to include location information associated with exposure time information of the image sensor; and adjust the initial exposure time to obtain a target exposure time for the image sensor based on real time parameters. The control unit is configured to control the exposure time by obtaining an initial exposure time for an image sensor based on the map data and adjusting the initial exposure time to obtain a target exposure time for the image sensor based on the real time parameters.

Implementations of the subject matter and the functional operations described in this patent document can be implemented in various systems, digital electronic circuitry, or in computer software, firmware, or hardware, including the structures disclosed in this specification and their structural equivalents, or in combinations of one or more of them. Implementations of the subject matter described in this specification can be implemented as one or more computer program products, e.g., one or more modules of computer program instructions encoded on a tangible and non-transitory computer readable medium for execution by, or to control the operation of, data processing apparatus. The computer readable medium can be a machine-readable storage device, a machine-readable storage substrate, a memory device, a composition of matter effecting a machine-readable propagated signal, or a combination of one or more of them. The term “data processing unit” or “data processing apparatus” encompasses all apparatus, devices, and machines for processing data, including by way of example a programmable processor, a computer, or multiple processors or computers. The apparatus can include, in addition to hardware, code that creates an execution environment for the computer program in question, e.g., code that constitutes processor firmware, a protocol stack, a database management system, an operating system, or a combination of one or more of them.

A computer program (also known as a program, software, software application, script, or code) can be written in any form of programming language, including compiled or interpreted languages, and it can be deployed in any form, including as a stand-alone program or as a module, component, subroutine, or other unit suitable for use in a computing environment. A computer program does not necessarily correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform functions by operating on input data and generating output. The processes and logic flows can also be performed by, and apparatus can also be implemented as, special purpose logic circuitry, e.g., an FPGA (field programmable gate array) or an ASIC (application specific integrated circuit).

Processors suitable for the execution of a computer program include, by way of example, both general and special purpose microprocessors, and any one or more processors of any kind of digital computer. Generally, a processor will receive instructions and data from a read only memory or a random access memory or both. The essential elements of a computer are a processor for performing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. In some implementations, however, a computer may not need such devices. Computer readable media suitable for storing computer program instructions and data include all forms of nonvolatile memory, media and memory devices, including by way of example semiconductor memory devices, e.g., EPROM, EEPROM, and flash memory devices. The processor and the memory can be supplemented by, or incorporated in, special purpose logic circuitry.

While this patent document contains many specifics, these should not be construed as limitations on the scope of any invention or of what may be claimed, but rather as descriptions of features that may be specific to particular embodiments of particular inventions. Certain features that are described in this patent document in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. Moreover, the separation of various system components in the embodiments described in this patent document should not be understood as requiring such separation in all embodiments.

Only a few implementations and examples are described and other implementations, enhancements and variations can be made based on what is described and illustrated in this patent document.

What is claimed is:

1. A method of controlling exposure time of an image sensor mounted on a vehicle, the method comprising:
configuring map data to include location information associated with exposure time information for the image sensor;
obtaining an initial exposure time for the image sensor based on the map data; and
adjusting the initial exposure time to obtain a target exposure time for the image sensor based on real time parameters.

2. The method of claim 1, wherein the adjusting the initial exposure time includes adjusting the initial exposure time based on weather information.

3. The method of claim 1, wherein the adjusting the initial exposure time includes adjusting the initial exposure time based on time of day information.

4. The method of claim 1, wherein the adjusting the initial exposure time includes adjusting the initial exposure time based on heading information of the vehicle that includes whether the vehicle is heading toward a light source.

5. The method of claim 1, wherein the adjusting the initial exposure time includes adjusting the initial exposure time based on light illumination information on an exterior of the vehicle that is obtained from a light sensor on the vehicle.

6. The method of claim 1, wherein the obtaining the initial exposure time includes obtaining the initial exposure time using a look-up table that maps inputs including the location of the vehicle and an identification of the image sensor to the initial exposure time.

7. The method of claim 1, further comprising: updating the exposure time information included in the map data based on the target exposure time.

8. A vehicle, including:
image sensors having respective identifications (IDs) and disposed at different locations of the vehicle to capture images regarding an environment external of the vehicle;
a control unit communicatively coupled to the image sensors and configured to control exposure time of the image sensors based on map data and real-time parameters such that the exposure time of the image sensors disposed at the different locations of the vehicle is controlled to be different from one another; and
one or more sensors communicatively coupled with the control unit and provide the real-time parameters to the control unit.

9. The vehicle of claim 8, wherein the control unit is configured to control the exposure time by obtaining an initial exposure time for an image sensor based on the map data and adjusting the initial exposure time to obtain a target exposure time for the image sensor based on the real time parameters.

10. The vehicle of claim 8, wherein the real-time parameters include: weather information, time information, information as to whether the vehicle is heading toward a light source, and light illumination information.

11. The vehicle of claim 8, wherein the one or more sensors include a light sensor configured to detect light illumination information around the vehicle.

12. The vehicle of claim 8, wherein the image sensors include a first image sensor disposed at a front portion of the vehicle and a second image sensor disposed at a rear portion of the vehicle, and wherein the exposure time of the first image sensor is controlled to have a value less than that of the second image sensor.

13. The vehicle of claim 8, wherein the image sensors include a first image sensor disposed at a front portion of the vehicle and a second image sensor disposed at a rear portion of the vehicle, and wherein the exposure time of the first image sensor is controlled to have a value greater than that of the second image sensor.

14. A system for controlling exposure time of an image sensor mounted on a vehicle, the system comprising:
a processor; and
a memory that comprises instructions stored thereupon, wherein the instructions, when executed by the processor, configure the processor to:
obtain an initial exposure time for the image sensor based on map data, wherein the map data is configured to include location information associated with exposure time information of the image sensor; and
adjust the initial exposure time to obtain a target exposure time for the image sensor based on real time parameters.

15. The system of claim 14, wherein the instructions further configure the processor to communicate with one or more circuitries configured to provide the real time parameters that include at least one of weather information, time of day information, light illumination information around the vehicle, or a heading information as to whether the vehicle is heading toward a light source.

16. The system of claim 14, wherein the instructions further configure the processor to communicate with a map server that is configured to store the map data and disposed outside the vehicle.

17. The system of claim 14, wherein the instructions further configure the processor to obtain the initial exposure time that is associated with the location information and an image sensor identification (ID) of the image sensor.

18. The system of claim 14, wherein the instructions further configure the processor to obtain the initial exposure time based on a location of the image sensor on the vehicle.

19. The system of claim 14, wherein the instructions further configure the processor to communicate with the image sensor to provide the target exposure time.

20. The system of claim 14, wherein the instruction further configure the processor to adjust the initial exposure time by applying different weights to the real parameters.
